(19) United States
(12) Patent Application Publication
(10) Pub. No.: US 2012/0017604 A1
(43) Pub. Date: Jan. 26, 2012

(54) GAS TURBINE ARRANGEMENT AND METHOD FOR RETROFITTING SAME

(75) Inventors: Marc RAUCH, Regensdorf (CH); Helmar WUNDERLE, Waldshut-Tiengen (DE); Peter BALDISCHWEILER, Schneisingen (CH); Ai Ling CHIN, Wettingen (CH)

(73) Assignee: ALSTOM Technology Ltd, Baden (CH)

(21) Appl. No.: 13/178,788

(22) Filed: Jul. 8, 2011

(30) Foreign Application Priority Data
Jul. 22, 2010 (EP) 10170375.9

(51) Int. Cl. F02C 7/20; B23P 17/00

(52) U.S. Cl. 60/796; 29/888

(57) ABSTRACT

A gas turbine arrangement includes a compressor, a combustion chamber and a turbine connected to one another. A casing housing the compressor has flanges connectable to pipes providing secondary air to at least one of the combustion chamber and the turbine. The flanges define passages having an asymmetric cross section. A method for retrofitting a gas turbine arrangement is also provided.

### RELATED APPLICATION

This application claims priority under 35 U.S.C. §119 to European Patent Application No. 10170375.9 filed in Europe on Jul. 22, 2010, the entire content of which is hereby incorporated by reference in its entirety.

### FIELD

The present disclosure relates to a gas turbine arrangement and a method for retrofitting the gas turbine arrangement.

### BACKGROUND INFORMATION

Gas turbine arrangements are known to include a compressor, wherein air is compressed and fed into a combustion chamber. In the combustion chamber, fuel is injected to form a mixture of air and fuel that is combusted, to then be expanded in a turbine.

In addition, during operation, air is extracted from the compressor for purposes different from the combustion; this is the so called secondary air, which is used, for example, for cooling purposes, as a purge air, and so on.

Conventionally, in order to extract air from the compressor, the compressor casing is provided with flanges defining circular passages.

In this respect, FIGS. 1 and 2 respectively show a front view and a perspective view of a compressor casing 1 having at its terminal portion first circular flanges 4 for connecting pipes feeding burners connected in turn to the combustion chamber.

Additionally, the terminal portion of the compressor casing 1 also has second flanges 5 for connecting pipes supplying the secondary air extracted from the compressor to the combustion chamber and/or turbine (according to the design).

In order to increase the gas turbine arrangement performances (for example, by increasing the flame temperature in the combustion chamber and correspondingly the temperature of the hot gases circulating in the turbine), a larger flow rate of secondary air is needed, for example, to cool the airfoils, other turbine components, or also those components close to the combustion chamber.

Increasing of the secondary air requires increasing the number or dimension of the second pipes. Nevertheless, this approach proved to be hardly feasible, because of the strict space constrains.

This problem is particularly relevant in case of retrofitting, since no design optimization is possible to achieve the desired secondary air flow rate.

### SUMMARY

An exemplary embodiment provides a gas turbine arrangement which includes a compressor, a combustion chamber and a turbine connected to one another. The exemplary gas turbine arrangement also includes a casing housing the compressor. The casing includes flanges connectable to pipes providing secondary air to at least one of the combustion chamber and the turbine. The flanges define passages having an asymmetric cross section.

An exemplary embodiment of the present disclosure provides a method for retrofitting a gas turbine arrangement which includes a compressor, a combustion chamber and a turbine connected to one another, and a casing housing the compressor. The casing has at least one flange defining passages having a symmetrical cross section, where the at least one flange is connected to pipes providing secondary air to at least one of the combustion chamber and the turbine. The exemplary method includes replacing the at least one flange defining passages having a symmetrical cross section with at least one flange defining passages having an asymmetrical cross section.

### BRIEF DESCRIPTION OF THE DRAWINGS

Additional refinements, advantages and features of the present disclosure are described in more detail below with reference to exemplary embodiments illustrated in the drawings, in which:

FIGS. 1 and 2 respectively show a front view and a perspective view of a compressor casing of a conventional gas turbine arrangement;

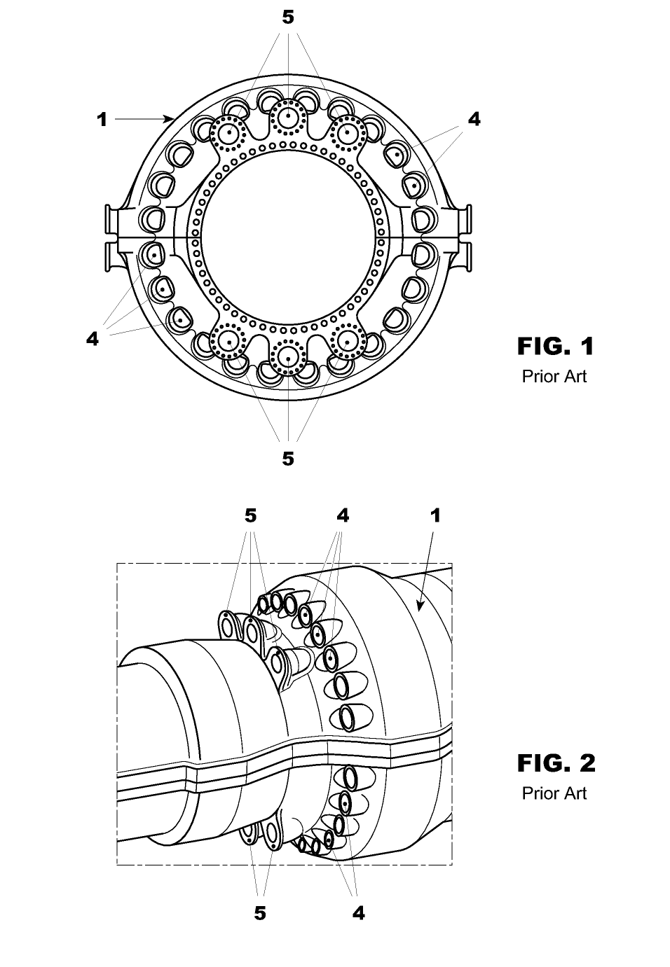

FIGS. 3 and 4 respectively show a front view and a perspective view of a compressor casing of a gas turbine arrangement in accordance with an exemplary embodiment of the present disclosure; and

FIG. 5 is a diagram schematically showing a gas turbine arrangement according to an exemplary embodiment of the present disclosure.

### DETAILED DESCRIPTION

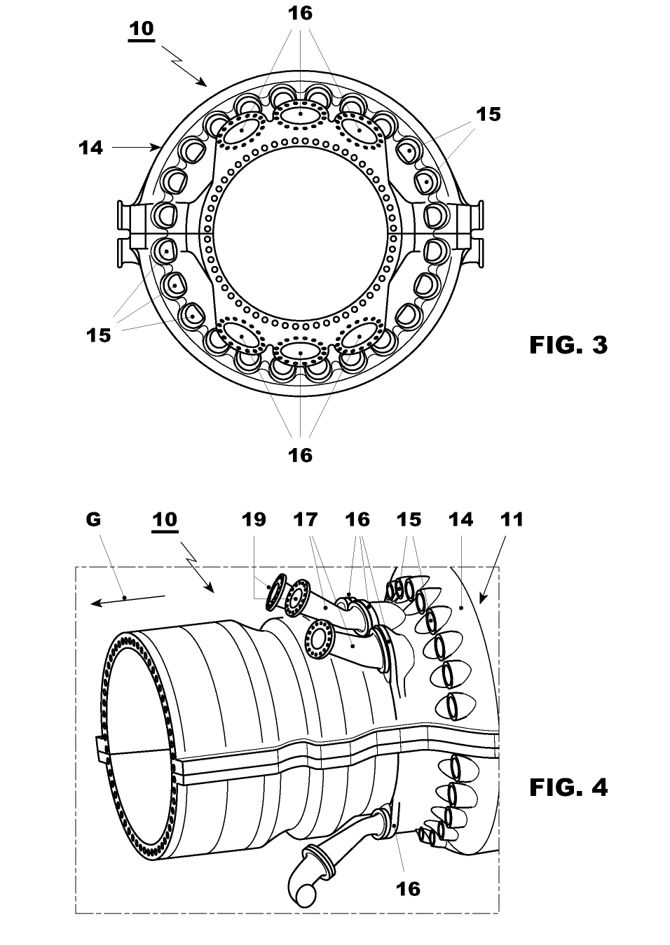

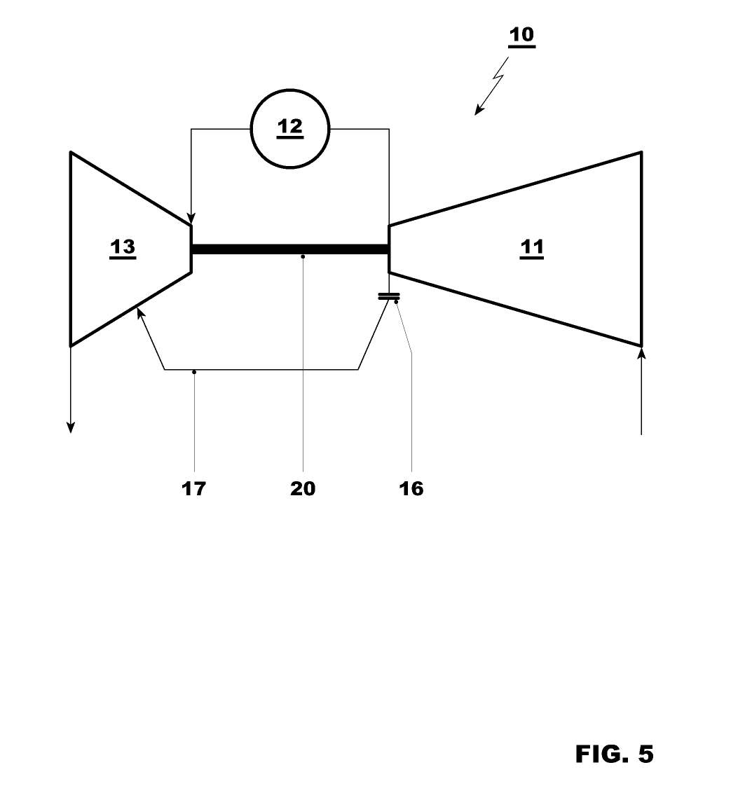

With reference to FIGS. 3 through 5, a gas turbine arrangement 10 is shown.

The gas turbine arrangement 10 includes a compressor 11, a combustion chamber 12 and a turbine 13 connected to one another.

Exemplary embodiments of the present disclosure provide a gas turbine arrangement and a method for retrofitting same addressing the aforementioned problems of the known art.

An exemplary embodiment of the present disclosure provides a gas turbine arrangement and a method allowing a large secondary air flow rate to be extracted from the compressor, while at the same time complying with the space constraints.

In accordance with an exemplary embodiment, a casing 14 housing the compressor 11 has first flanges 15 for connecting burners that feed the combustion chamber 12.

In addition, the casing 14 has second flanges 16 connectable to pipes 17 providing secondary air to the combustion chamber 12 and/or the turbine 13. FIG. 4 shows the pipes 17 actually connected to the flanges 16.

The flanges 16 define passages having an asymmetric cross section, such as an oval cross section, for example.

Correspondingly, the pipes 17 have an asymmetrical inlet cross section, such as an oval inlet cross section (to be connected to the flanges 16), for example, and a symmetrical outlet cross section 19, such as a circular outlet cross section, for example.

Traditional pipes having a circular cross section over their whole length are connected between the flanges 19 and flanges of the casing of the combustion chamber 12 or turbine 13.

As shown in the FIGS. 3 to 5, the flanges 16 are located downstream of the flanges 15 (with respect to the hot gases direction indicated by arrow G) and the pipes 17 are located between the burners and an arrangement shaft 20.

Exemplary embodiments of the present disclosure also provide a method for retrofitting the gas turbine arrangement 10.

The method includes replacing the flanges 5 defining passages having a symmetrical cross section with flanges 16 defining passages having an asymmetrical cross section.

Such replacement may be achieved by cutting a relevant part of the casing having the flanges 5 and then connecting, for example, by welding, a new part having the flanges 16. Alternatively, in case the flanges 5 are included in a plate (for example, an annular plate) that defines a portion of the casing and is connected to the rest of the casing by removable means such as bolts, the plate could be dismounted and replaced by another plate, having the flanges 16.

Naturally, the features described may be independently provided from one another.

In practice, the materials used and the dimensions can be chosen at will according to requirements and to the state of the art.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCE NUMBERS

1 compressor casing
4 first flanges
5 second flanges
10 gas turbine arrangement
11 compressor
12 combustion chamber
13 turbine
14 casing of 11
15 first flanges
16 second flanges
17 pipes
19 outlet cross section of 17
20 shaft
G direction of the hot gases

What is claimed is:

1. A gas turbine arrangement comprising:
a compressor, a combustion chamber and a turbine connected to one another; and
a casing housing the compressor,
wherein the casing includes flanges connectable to pipes providing secondary air to at least one of the combustion chamber and the turbine,
wherein the flanges define passages having an asymmetric cross section.

2. The gas turbine arrangement as claimed in claim 1, wherein the asymmetric cross section is an oval cross section.

3. A method for retrofitting a gas turbine arrangement including a compressor, a combustion chamber and a turbine connected to one another, and a casing housing the compressor, the casing having at least one flange defining passages having a symmetrical cross section, the at least one flange being connected to pipes providing secondary air to at least one of the combustion chamber and the turbine, wherein the method comprises:
replacing the at least one flange defining passages having the symmetrical cross section with at least one flange defining passages having an asymmetrical cross section.

4. The method as claimed in claim 3, wherein the replacing of the at least one flange comprises replacing the at least one flange having the symmetrical cross section with at least one flange defining passages having an asymmetrical cross section which is an oval cross section.

5. The method as claimed in claim 3, wherein the replacing comprises cutting a part of the casing having the at least one flange defining passages having the symmetrical cross section and connecting the at least one flange defining passages having the asymmetrical cross section to the part of the casing from which the at least one flange defining passages having the symmetrical cross section was cut.

6. The method as claimed in claim 5, wherein the connecting comprises welding the at least one flange defining passages having the asymmetrical cross section to the part of the casing from which the at least one flange defining passages having the symmetrical cross section was cut.

7. The method as claimed in claim 3, wherein the replacing comprises removing a portion of the casing including the at least one flange defining passages having the symmetrical cross section, and affixing the at least one flange defining passages having the asymmetrical cross section to the casing.

8. The method as claimed in claim 7, wherein the at least one flange defining passages having the asymmetrical cross section is affixed to the casing by means of a removable connection mechanism.

9. The method as claimed in claim 7, wherein the removable connection mechanism includes a bolt.
